(19) United States
(12) Patent Application Publication
(10) Pub. No.: US 2026/0113799 A1
(43) Pub. Date: Apr. 23, 2026

(54) METHOD AND DEVICE FOR SUPPRESSING CONNECTION OF UNCREWED AERIAL VEHICLE IN WIRELESS COMMUNICATION SYSTEM

(71) Applicant: SAMSUNG ELECTRONICS CO., LTD., Suwon-si, Gyeonggi-do (KR)

(72) Inventors: Sangyeob JUNG, Suwon-si (KR); Anil AGIWAL, Suwon-si (KR)

(21) Appl. No.: 18/865,219

(22) PCT Filed: May 12, 2023
(86) PCT No.: PCT/KR2023/006496

§ 371 Date: Nov. 12, 2024

(30) Foreign Application Priority Data
May 12, 2022 (KR) 10-2022-0058474

(51) Int. Cl. H04W 76/20; H04W 36/08; H04W 84/06

(52) U.S. Cl. CPC H04W 76/20; H04W 36/08; H04W 84/06

(57) ABSTRACT

The present disclosure relates to a 5G or 6G communication system for supporting higher data transmission rates. According to various embodiments disclosed herein, a method performed by an uncrewed aerial vehicle (UAV) terminal in a radio resource control (RRC)_IDLE or RRC_INACTIVE state may be provided. The method may include the steps of: receiving a message including system information from a base station, wherein the system information includes first information indicating whether it is possible to connect the UAV terminal; and performing camp-on on the base station on the basis of the first information in response to the message including the received system information.

### TECHNICAL FIELD

The disclosure relates to a method and a device for suppressing connection of an uncrewed aerial vehicle in a wireless communication system.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to provide methods for efficient integrated access and backhaul node control.

### DISCLOSURE OF INVENTION

### Technical Problem

Disclosed embodiments provide a device and a method capable of effectively provide a service in a wireless communication system.

### Solution to Problem

According to various embodiments of the disclosure, a method performed by an uncrewed aerial vehicle (UAV) UE in a radio resource control RRC)_IDLE or an RRC_INACTIVE state may be provided. The method may include receiving a message including system information from a base station, wherein the system information includes first information indicating whether the UAV UE can be connected, and performing, based on the first information, camp-on on the base station in response to the received message including the system information.

According to various embodiments of the disclosure, a method performed by a base station may be provided. The method may include transmitting a message including system information to an uncrewed aerial vehicle (UAV) UE in a radio resource control (RRC)_IDLE or an RRC_INACTIVE state, wherein the system information includes first information indicating whether the UAV UE can be connected, and performing, based on the first information, communication with the UAV UE in the RRC_IDLE or RRC_INACTIVE state in response to the transmitted message including the system information.

According to various embodiments of the disclosure, an uncrewed aerial vehicle (UAV) UE in a radio resource control (RRC)_IDLE or an RRC_INACTIVE state may be provided. The UAV UE in the RRC_IDLE or the RRC_INACTIVE state may include a transceiver and a controller connected to the transceiver, wherein the controller is configured to receive a message including system information from a base station, the system information including first information indicating whether the UAV UE can be connected, and performing, based on the first information, camp-on on the base station in response to the received message including the system information.

According to various embodiments of the disclosure, a base station may include a transceiver and a controller connected to the transceiver, wherein the controller is configured to transmit a message including system information to an uncrewed aerial vehicle (UAV) UE in a radio resource control (RRC)_IDLE or an RRC_INACTIVE state, the system information including first information indicating whether the UAV UE can be connected, and performing, based on the first information, communication with the UAV UE in the RRC_IDLE or RRC_INACTIVE state in response to the transmitted message including the system information.

According to an embodiment of the disclosure, a method performed by an uncrewed aerial vehicle (UAV) UE in a radio resource control (RRC)_IDLE or an RRC_INACTIVE states is provided.

The method includes receiving a message including system information, wherein the system information includes first information indicating whether the UAV UE can be connected, second information indicating whether the UAV UE can reselect neighboring cells using an identical frequency, and third information indicating a height threshold.

The method includes performing, based on the first information indicating whether the UAV UE can be connected, camp-on on the cell in case that the height of the UAV UE is equal to or greater than the height threshold.

The method includes reselecting, based on the second information indicating whether the UAV UE can reselect neighboring cells using the same frequency, neighboring cells using the same frequency as the cell in case that the height of the UAV UE is equal to or greater than the height threshold.

### Advantageous Effects of Invention

Disclosed embodiments provide a device and a method capable of effectively providing a service in a mobile communication system.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF DRAWINGS

FIG. 1A illustrates a structure of an LTE system in a wireless communication system according to an embodiment of the disclosure.

FIG. 1B illustrates a radio protocol structure of an LTE system in a wireless communication system according to an embodiment of the disclosure.

FIG. 1C illustrates a structure of a next-generation mobile communication system in a wireless communication system according to an embodiment of the disclosure.

FIG. 1D is a diagram illustrating a radio protocol structure of a next-generation mobile communication system in a wireless communication system according to an embodiment of the disclosure.

FIG. 1E illustrates a method for accessing a cell by an uncrewed aerial vehicle (UAV) UE in a wireless communication system according to an embodiment of the disclosure.

FIG. 1F illustrates a method for accessing a cell by an uncrewed aerial vehicle (UAV) UE in a wireless communication system according to an embodiment of the disclosure.

FIG. 1G illustrates a method for accessing a cell by an uncrewed aerial vehicle (UAV) UE in a wireless communication system according to an embodiment of the disclosure.

FIG. 1H illustrates a process of performing UE access control in a wireless communication system according to an embodiment of the disclosure.

FIG. 1I is a flow chart of a process of performing access control of the conventional UE in a wireless communication system according to an embodiment.

FIG. 1J is a flow chart of a process of performing access control in a wireless communication system according to an embodiment of the disclosure.

FIG. 1K is a flow chart of a process of performing access control in a wireless communication system according to an embodiment of the disclosure.

FIG. 1L illustrates configuring new physical random access channel (PRACH) parameters prioritization for a UAV UE by a new radio (NR) base station in a wireless communication system according to an embodiment of the disclosure.

FIG. 1M is a block diagram illustrating an internal structure of a UE in a wireless communication system according to an embodiment of the disclosure.

FIG. 1N is a block diagram illustrating a configuration of an NR base station in a wireless communication system according to an embodiment of the disclosure.

### MODE FOR CARRYING OUT THE INVENTION

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may refer to “gNB”.

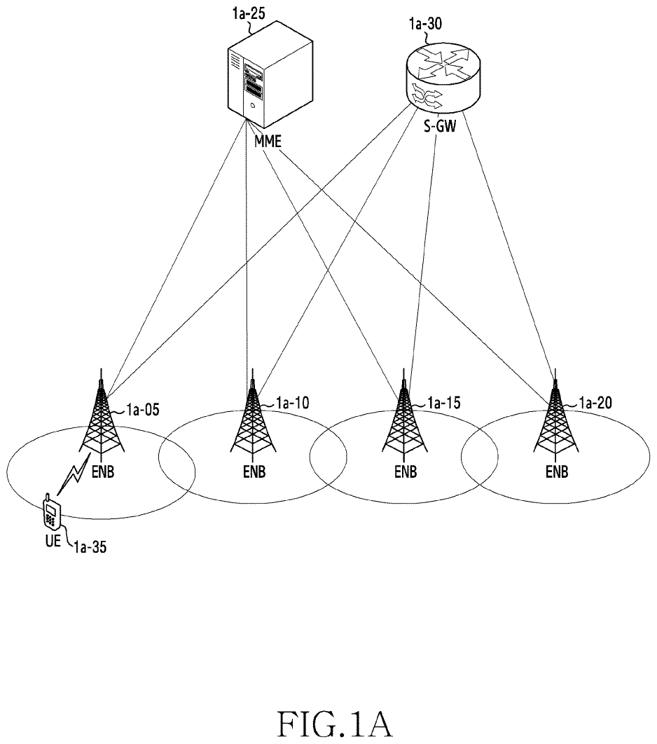

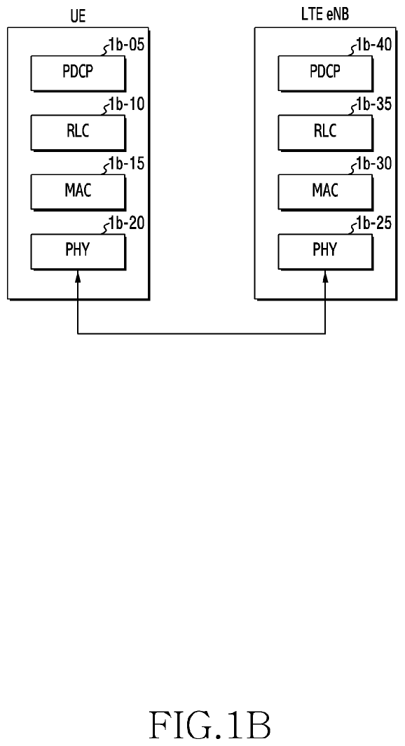

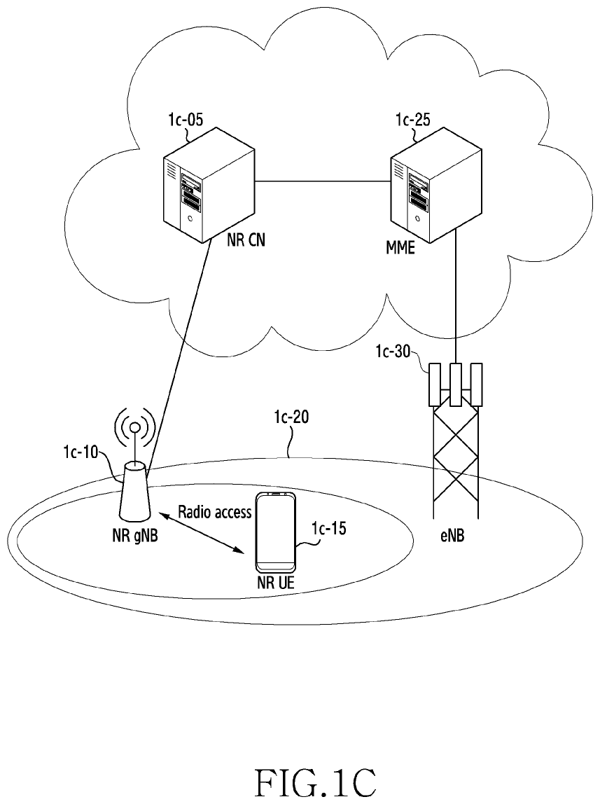

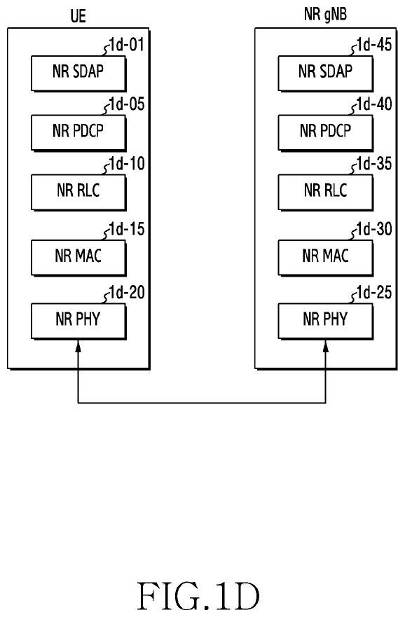

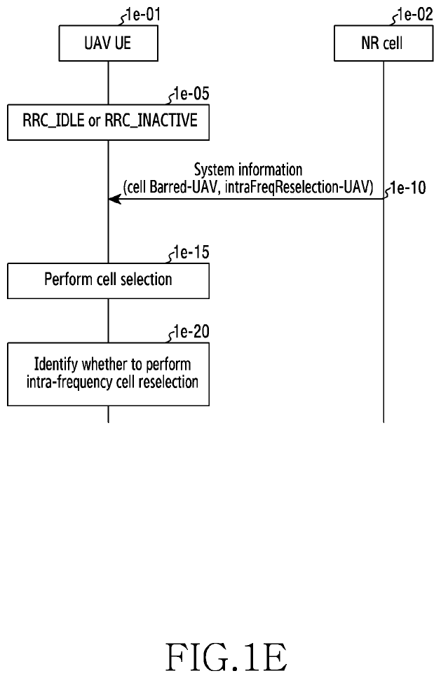

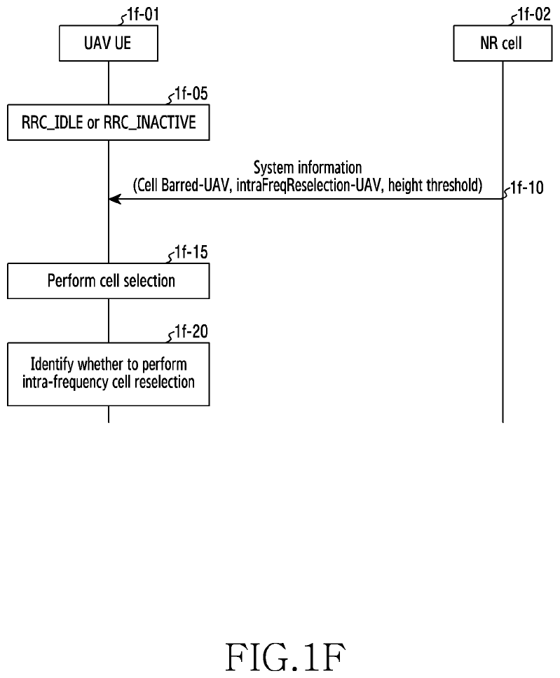

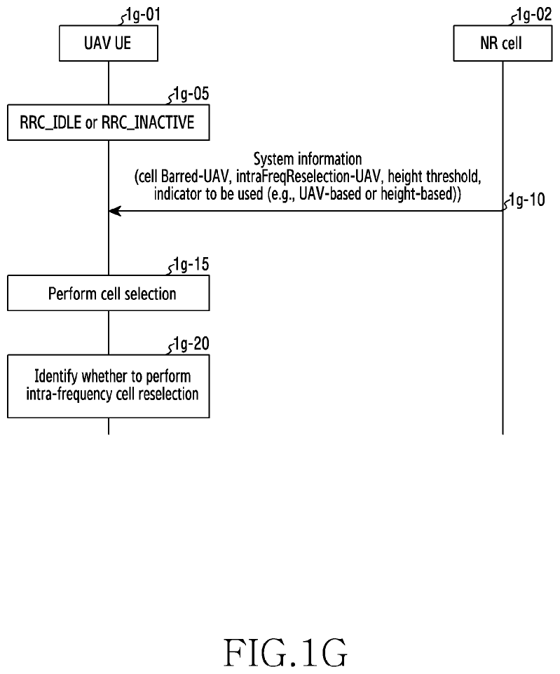

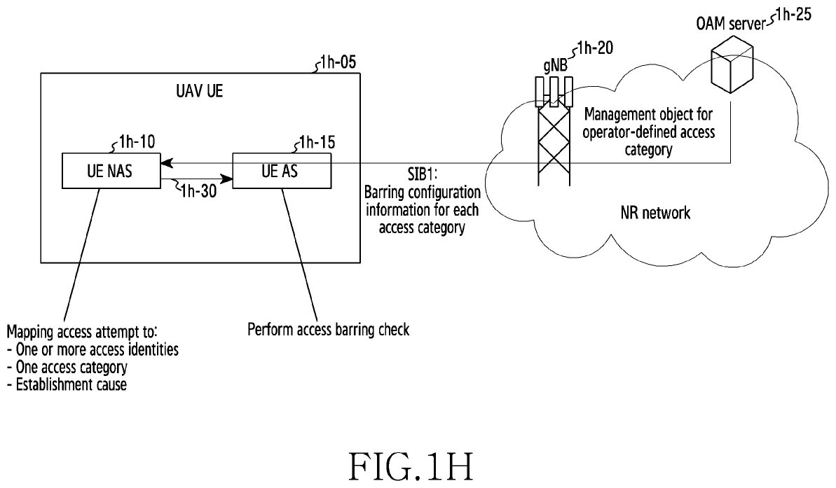

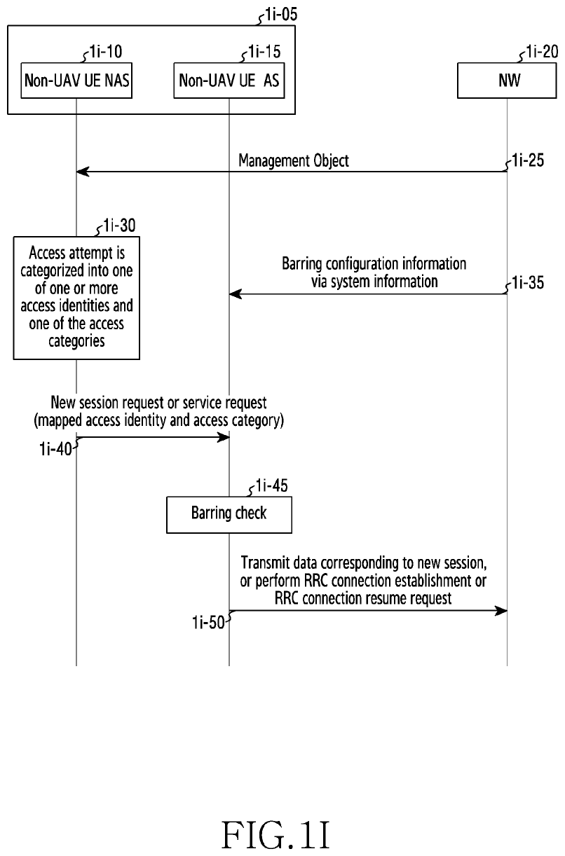

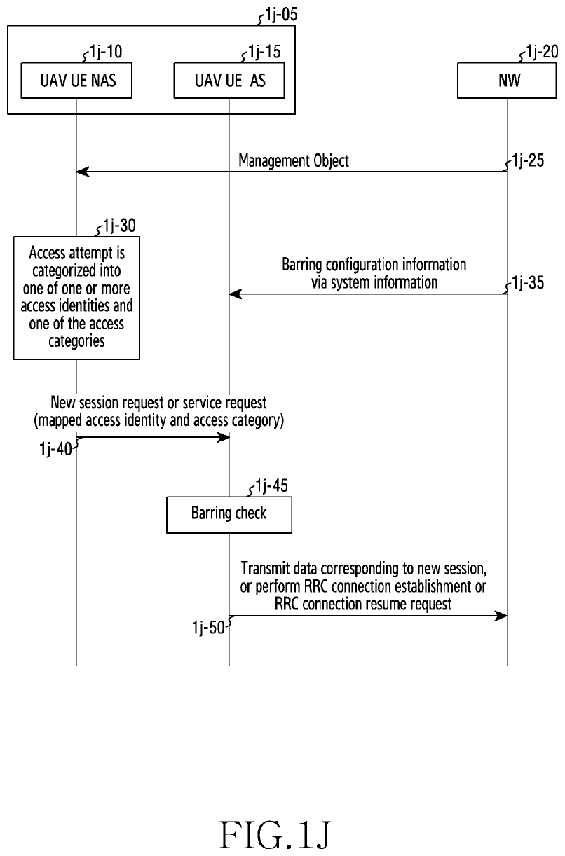

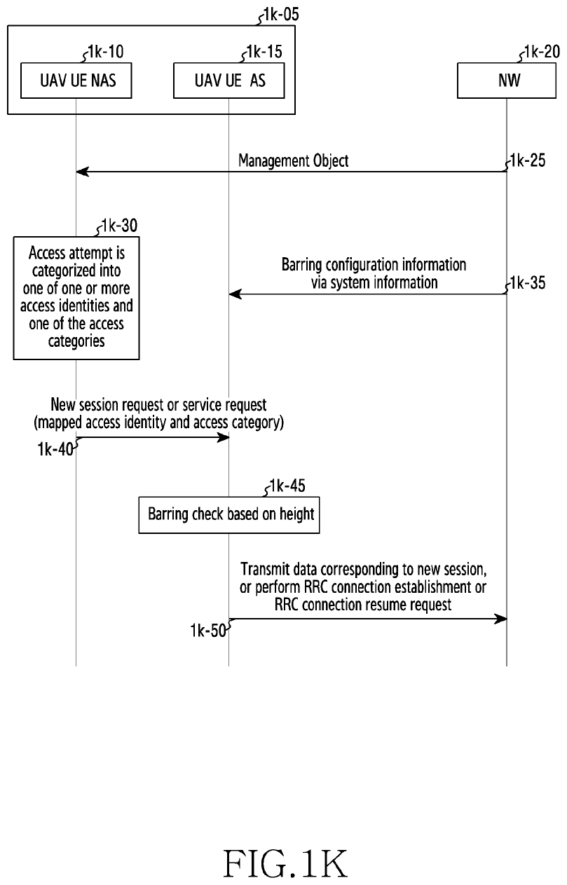

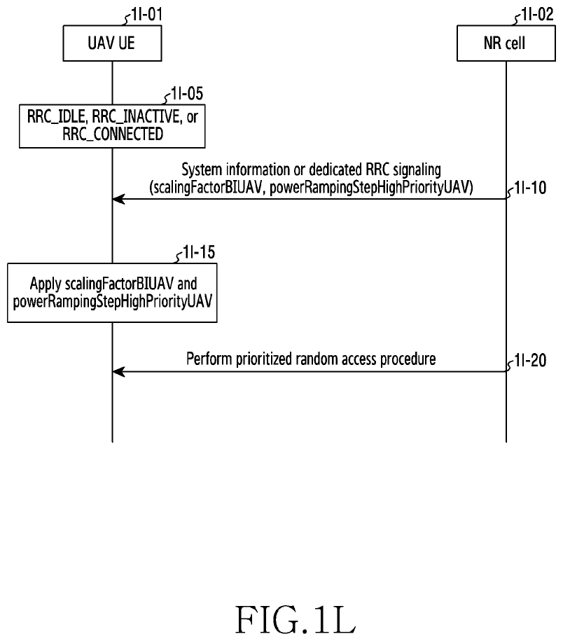

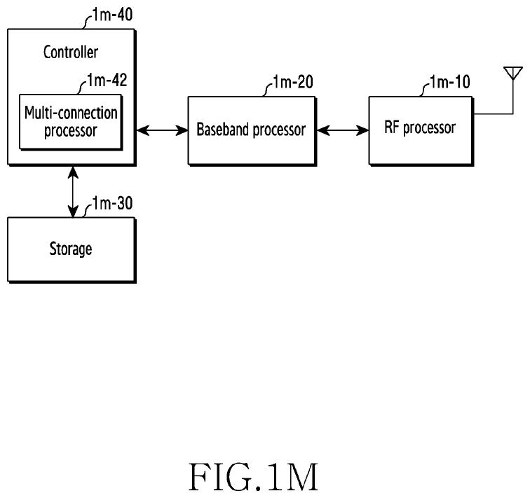

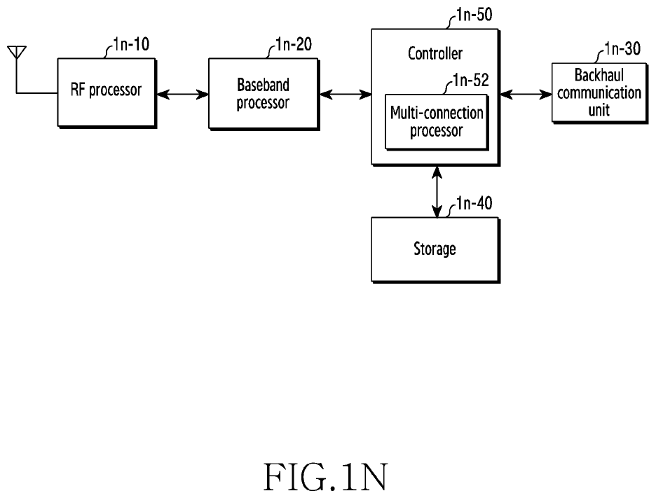

FIG. 1A illustrates a structure of an LTE system in a wireless communication system according to an embodiment of the disclosure.

Referring to FIG. 1A, as illustrated therein, a radio access network of an LTE system includes next-generation base stations (evolved node Bs, hereinafter eNBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 accesses an external network through the eNBs 1a-05 to 1a-20 and the S-GW 1a-30.

In FIG. 1A, the eNBs 1a-05 to 1a-20 each correspond to a conventional node B in a UMTS system. The eNBs are connected to the UE 1a-35 through a radio channel, and perform more complicated roles than the conventional node Bs. In the LTE system, since all user traffic including real-time services, such as voice over IP (VOIP) via the Internet protocol, is serviced through a shared channel, a device that collects information and performs scheduling accordingly is required. For example, the collected information may include state information, such as buffer states, available transmit power states, and channel states of UEs. According to an embodiment of the disclosure, the eNBs 1a-05 to 1a-20 serve as the device that performs scheduling. In general, one eNB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Furthermore, the LTE system employs an adaptive modulation & coding (hereinafter referred to as AMC) scheme for determining a modulation scheme and a channel coding rate according to a channel state of a UE. The S-GW 1a-30 is a device that provides a data bearer, and generates or removes a data bearer under the control of the MME 1a-25. The MME is a device responsible for various control functions as well as a mobility management function for a UE, and is connected to multiple base stations.

FIG. 1B illustrates a radio protocol structure of an LTE system in a wireless communication system according to an embodiment of the disclosure.

Referring to FIG. 1B, a radio protocol of an LTE system includes a packet data convergence protocol (PDCP) 1b-05 or 1b-40, a radio link control (RLC) 1b-10 or 1b-35, and a medium access control (MAC) 1b-15 or 1b-30 on each of UE and eNB sides. The packet data convergence protocol (PDCP) 1b-05 or 1b-40 is responsible for operations such as IP header compression/reconstruction. The main functions of the PDCP are summarized as follows.
Header compression and decompression: ROHC only
Transfer of user data
In-sequence delivery of upper layer PDUs at PDCP re-establishment procedure for RLC AM
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) 1b-10 or 1b-35 reconfigures a PDCP protocol data unit (PDU) into an appropriate size to perform an ARQ operation. The main functions of the RLC are summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 1b-15 or 1b-30 is connected to several RLC layer devices configured in a single terminal, and performs operations of multiplexing RLC PDUs to a MAC PDU and demultiplexing a MAC PDU to RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

A physical layer 1b-20 or 1b-25 performs operations of channel-coding and modulating upper layer data, thereby obtaining OFDM symbols, and delivering the same through a radio channel, or demodulating OFDM symbols received through the radio channel, channel-decoding the same, and delivering the same to the upper layer.

FIG. 1C illustrates a structure of a next-generation mobile communication system in a wireless communication system according to an embodiment of the disclosure.

Referring to FIG. 1C, as illustrated therein, a radio access network of a next-generation mobile communication system (hereinafter new radio (NR) or 5G) includes a next-generation base station (new radio node B, hereinafter NR gNB or NR base station) 1c-10, and a new radio core network (NR CN) 1c-05. A user terminal (new radio user equipment, hereinafter NR UE or NR terminal) 1c-15 accesses an external network via the NR gNB 1c-10 and the NR CN 1c-05.

In FIG. 1C, the NR gNB 1c-10 corresponds to an evolved node B (eNB) of a conventional LTE system. The NR gNB 1c-10 is connected to the NR UE 1c-15 through a radio channel, and can provide outstanding services as compared to a conventional node Bs. In the next-generation mobile communication system, since all user traffic is serviced through a shared channel, a device that collects information and performs scheduling accordingly is required. For example, the collected information may include state information, such as buffer states, available transmit power states, and channel states of UEs. According to an embodiment of the disclosure, the NR gNB 1c-10 serves as the device that performs scheduling. In general, one NR gNB controls multiple cells. In order to implement data transmission at an ultrahigh speed compared to the current LTE, bandwidths in the next-generation mobile communication system may be above the existing maximum bandwidth. According to an embodiment of the disclosure, the next-generation mobile communication system may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The NR CN 1c-05 performs functions such as mobility support, bearer configuration, and QoS configuration. The NR CN is a device responsible for various control functions as well as a mobility management function for a UE, and is connected to multiple base stations. In addition, the next-generation mobile communication system may interwork with the existing LTE system, and the NR CN is connected to an MME 1c-25 via a network interface. The MME is connected to an eNB 1c-30 that is an existing base station.

FIG. 1D illustrates a radio protocol structure of a next-generation mobile communication system in a wireless communication system according to an embodiment of the disclosure.

FIG. 1D illustrates a radio protocol structure of a next-generation mobile communication system to which the disclosure is applicable.

Referring to FIG. 1D, a radio protocol of a next-generation mobile communication system includes an NR SDAP 1d-01 or 1d-45, an NR PDCP 1d-05 or 1d-40, an NR RLC 1d-10 or 1d-35, and an NR MAC 1d-15 or 1d-30 on each of UE and NR base station sides.

The main functions of the NR SDAP 1d-01 or 1d-45 may include some of functions below.
Transfer of user plane data
Mapping between a QoS flow and a DRB for both DL and UL
Marking QoS flow ID in both DL and UL packets
Reflective QoS flow to DRB mapping for UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the NAS QoS reflection configuration 1-bit indicator (NAS reflective QoS) of the SDAP header and the AS QoS reflection configuration 1-bit indicator (AS reflective QoS) thereof may be indicated by the NR base station, so that the UE can update or reconfigure mapping information. For example, the mapping information may include mapping information regarding the QoS flows and data bearers of the uplink and downlink. The SDAP header may include QoS flow ID information indicating the QoS. The QoS flow ID information may be used as data processing priority, scheduling information, etc. for smoothly supporting services.

The main functions of the NR PDCP 1d-05 or 1d-40 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs). The reordering of the NR PDCP device may include a function of transferring data to an upper layer in the reordered sequence. In addition, the reordering of the NR PDCP device may include a function of directly transferring data without considering the sequence. According to an embodiment of the disclosure, the reordering of the NR PDCP device may include a function of rearranging the sequence to record lost PDCP PDUs. According to an embodiment of the disclosure, the reordering of the NR PDCP device may include a function of reporting the state of lost PDCP PDUs to a transmission side. According to an embodiment of the disclosure, the reordering of the NR PDCP device may include a function of requesting retransmission of lost PDCP PDUs.

The main functions of the NR RLC 1d-10 or 1d-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of delivering RLC SDUs, received from the lower layer, to the upper layer in sequence. According to an embodiment of the disclosure, the in-sequence delivery of the NR RLC device may include a function of, if one original RLC SDU is segmented into multiple RLC SDUs and the segmented RLC SDUs are received, reassembling the RLC SDUs and delivering the reassembled RLC SDUs. According to an embodiment of the disclosure, the in-sequence delivery of the NR RLC device may include a function of rearranging received RLC PDUs with respect to RLC sequence numbers (SNs) or PDCP sequence numbers (SNs). According to an embodiment of the disclosure, the in-sequence delivery of the NR RLC device may include a function of rearranging the sequence to record lost RLC PDUs. According to an embodiment of the disclosure, the in-sequence delivery of the NR RLC device may include a function of reporting the state of lost RLC PDUs to a transmission side. According to an embodiment of the disclosure, the in-sequence delivery of the NR RLC device may include a function of requesting retransmission of lost RLC PDUs. According to an embodiment of the disclosure, the in-sequence delivery of the NR RLC device may include a function of, if there is a lost RLC SDU, sequentially delivering only RLC SDUs before the lost RLC SDU to the upper layer. According to an embodiment of the disclosure, the in-sequence delivery of the NR RLC device may include a function of, although there is a lost RLC SDU, if a predetermined timer has expired, sequentially delivering, to the upper layer, all the RLC SDUs received before the timer is started. According to an embodiment of the disclosure, the in-sequence delivery of the NR RLC device may include a function of, although there is a lost RLC SDU, if a predetermined timer has expired, sequentially delivering, to the upper layer, all the RLC SDUs received up to the current time. According to an embodiment of the disclosure, the in-sequence delivery of the NR RLC device may process RLC PDUs in the sequence of reception (regardless of the sequence of sequence numbers and in the sequence of arrival) and deliver same to the PDCP device regardless of the sequence (out-of-sequence delivery). According to an embodiment of the disclosure, the in-sequence delivery of the NR RLC device may, in the case where RLC PDUs are segments, receive segments which are stored in a buffer or which are to be received later, reconfigure same into one complete RLC PDU, and then process and deliver same to the PDCP device. The NR RLC layer may include no concatenation function, which may be performed in the NR MAC layer or replaced with a multiplexing function of the NR MAC layer.

The out-of-sequence delivery of the NR RLC device refers to a function of directly delivering RLC SDUs received from the lower layer to the upper layer regardless of the sequence. According to an embodiment of the disclosure, the out-sequence delivery of the NR RLC device may include a function of, if one original RLC SDU is segmented into multiple RLC SDUs and the segmented RLC SDUs are received, reassembling the RLC SDUs and delivering the reassembled RLC SDUs. According to an embodiment of the disclosure, the out-of-sequence delivery function of the NR RLC device may include a function of storing RLC sequence numbers (SNs) or PDCP SNs of received RLC PDUs and arranging the sequence to record lost RLC PDUS.

The NR MAC 1d-15 or 1d-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1d-20 or 1d-25 may perform operations of channel-coding and modulating upper layer data, thereby obtaining OFDM symbols, and delivering the same through a radio channel. According to an embodiment of the disclosure, the NR PHY layer may perform operations of demodulating OFDM symbols received through the radio channel, channel-decoding the same, and delivering the same to the upper layer.

FIG. 1E illustrates a method for accessing a cell by an uncrewed aerial vehicle (UAV) UE in a wireless communication system according to an embodiment of the disclosure.

The UAV UE may have a feature enabling a probability of a higher line of sight than that of a terrestrial UE. Therefore, compared to the terrestrial UE, the UAV UE may have a disadvantage of receiving downlink (hereinafter, referred to as DL) interference from more cells. That is, the UAV UE may receive a higher level of DL interference from more neighboring cells than those of the terrestrial UE. Similarly, the UAV UE may cause uplink (hereinafter, referred to as UL) interference to more cells than the terrestrial UE. A barring method according to the feature of the UAV UE is proposed in the disclosure.

Referring to FIG. 1E, in operation 1e-05, a UAV UE 1e-01 may be in an RRC idle mode (RRC_IDLE) or an RRC inactive mode (RRC_INACTIVE) since no RRC connection with an NR cell 1e-02 is configured.

In operation 1e-10, the UAV UE 1e-01 in the RRC idle mode or the RRC inactive state may acquire essential system information and other system information (SIB2, SIB3, etc.) from the NR cell 1e-02. In the disclosure, a master information block (MIB) and system information block 1 (SIB1) may be referred to as essential system information. The disclosure proposes broadcasting, via SIB1 or other system information, information (cellBarred-UAV) indicating whether the UAV UE 1e-01 can access the NR cell 1e-02. The information (cellBarred-UAV) may be one bit, and may be information indicating whether it is barred or non-barred. The disclosure proposes broadcasting, via SIB1 or other system information by the NR cell, information (intraFreqReselection-UAV) indicating whether neighboring cells using the same frequency as the NR cell 1e-02 can be reselected. The information (intraFreqReselection-UAV) may be indicated as “allowed” or “nonallowed”.

In operation 1e-15, the UAV UE 1e-01 in the RRC idle mode or the RRC inactive state may perform, based on the essential system information acquired in operation 1e-10, a cell selection procedure. For example, the UAV UE 1e-01 in the RRC idle mode or the RRC inactive state may search for an NR suitable cell belonging to a selected PLMN or SNPN to perform camp-on on the corresponding cell. The cell on which the UAV UE 1e-01 in the RRC idle mode or the RRC inactive state performs camp-on may be referred to as a serving cell. In the disclosure, the cell may be defined as a suitable cell when the conditions in Table 1 below are fulfilled based on the 3GPP standard document “38.304: User Equipment (UE) procedures in Idle mode and RRC Inactive state”.

TABLE 1

suitable cell:
For UE not operating in SNPN Access Mode, a cell is considered as suitable if

the following conditions are fulfilled:

-The cell is part of either the selected PLMN or the registered PLMN or PLMN

of the Equivalent PLMN list, and for that PLMN either:

-The PLMN-ID of that PLMN is broadcast by the cell with no associated CAG-

IDs and CAG-only indication in the UE for that PLMN (TS 23.501 [10]) is absent or
false;

-Allowed CAG list in the UE for that PLMN (TS 23.501 [10]) includes a CAG-

ID broadcast by the cell for that PLMN;

-The cell selection criteria are fulfilled, see clause 5.2.3.2.
According to the latest information provided by NAS:
-The cell is not barred, see clause 5.3.1;
-The cell is part of at least one TA that is not part of the list of “Forbidden

Tracking Areas for Roaming” (TS 22.011 [18]), which belongs to a PLMN that fulfils
the first bullet above.

For UE operating in SNPN Access Mode, a cell is considered as suitable if the

following conditions are fulfilled:

-The cell is part of either the selected SNPN or the registered SNPN of the UE;
-The cell selection criteria are fulfilled, see clause 5.2.3.2;
According to the latest information provided by NAS:
-The cell is not barred, see clause 5.3.1;
-The cell is part of at least one TA that is not part of the list of “Forbidden

Tracking Areas for Roaming” which belongs to either the selected SNPN or the registered
SNPN of the UE.

For reference, the UAV UE 1e-01 in the RRC idle mode or the RRC inactive state may determine that that cell selection criteria are fulfilled when a mathematical expression below is satisfied.

$$Srxlev > 0 AND Squal > 0 \qquad [ Mathematical expression 1 ]$$

$$where$$

$$Srxlev = {Q}_{rxlevmeas} - ( {Q}_{rxlevmin} + {Qr}_{xlevminoffset} ) - {P}_{compensation} - ¬ {Qoffset}_{temp} ,$$

$$Squal = {Q}_{qualmeas} - ( {Q}_{qualmin} + {Q}_{qualminoffset} ) - {Qoffset}_{temp} .$$

The definitions of parameters used herein refer to the 3GPP standard document “38.304: User Equipment (UE) procedures in Idle mode and RRC Inactive state”.

In operation 1e-15, the UAV UE 1e-01 in the RRC idle mode or the RRC inactive state proposes not to perform camp-on on the NR cell 1e-02 when cellBarred-UAV is broadcasted via SIB1 or other system information or the cellBarred-UAV is indicated as “barred”. That is, when the cellBarred-UAV information is not broadcasted or the cellBarred-UAV information is indicated as “nonBarred”, the UAV UE 1e-01 in the RRC idle mode or the RRC inactive state may perform camp-on when the NR cell 1e-01 is a suitable cell. For reference, when a cellBarred indicator is set to “barred” in the MIB, the UAV UE 1e-01 in the RRC idle mode or the RRC inactive state may ignore the same and determine whether to select or reselect a cell according to the cellBarred-UAV. In a case where the UE is not the UAV UE, i) access to the corresponding cell may fail when the cellBarred indicator in the MIB is indicated as “barred”, or ii) access to the corresponding cell may fail when cellReservedForOperatorUse in SIB1 is reserved, cellReservedForOtherUse is true, or cellReservedForFutureUse is true.

In operation 1e-20, the UAV UE 1e-01 in the RRC idle mode or the RRC inactive state may reselect neighboring cells using the same frequency as the NR cell 1e-02 when intraFreqReselection-UAV in SIB1 or other system information is indicated as “allowed”. When the intraFreqReselection UAV is indicated as “nonallowed”, the UAV UE 1e-01 in the RRC idle mode or the RRC inactive state cannot reselect neighboring cells using the same frequency as the NR cell 1e-02 for 300 seconds.

The disclosure proposes applying a parameter of new cell reservations and access restrictions that are newly proposed (for example, cellBarred-UAV and/or intraFreqReselection-UAV in SIB), instead of applying a parameter (for example, cellBarred and/or intraFreqReselection in MIB) of the conventional cell reservations and access restrictions in the MIB and SIB1.

FIG. 1F illustrates a method for accessing a cell by an uncrewed aerial vehicle (UAV) UE in a wireless communication system according to an embodiment of the disclosure.

The UAV UE may have a feature enabling a probability of a higher line of sight than that of a terrestrial UE. Therefore, compared to the terrestrial UE, the UAV UE may have a disadvantage of receiving downlink (hereinafter, referred to as DL) interference from more cells. That is, the UAV UE may receive a higher level of DL interference from more neighboring cells than those of the terrestrial UE. Similarly, the UAV UE may cause uplink (hereinafter, referred to as UL) interference to more cells than the terrestrial UE. A barring method according to the feature of the UAV UE is proposed in the disclosure.

Referring to FIG. 1F, in operation 1f-05, a UAV UE 1f-01 may be in an RRC idle mode (RRC_IDLE) or an RRC inactive mode (RRC_INACTIVE) since no RRC connection with an NR cell 1f-02 is configured.

In operation 1f-10, the UAV UE 1f-01 in the RRC idle mode or the RRC inactive state may acquire essential system information and other system information (SIB2, SIB3, etc.) from the NR cell 1f-02. In the disclosure, a master information block (MIB) and system information block 1 (SIB1) may be referred to as essential system information. The disclosure proposes broadcasting, via SIB1 or other system information, information (cellBarred-UAV) indicating whether the UAV UE 1f-01 can access the NR cell 1e-02. The information (cellBarred-UAV) may be one bit, and may be information indicating whether it is barred or non-barred. The disclosure proposes broadcasting, via SIB1 or other system information by the NR cell, information (intraFreqReselection-UAV) indicating whether neighboring cells using the same frequency as the NR cell 1e-02 can be reselected. The information (intraFreqReselection-UAV) may be indicated as “allowed” or “nonallowed”. The disclosure proposes broadcasting, via SIB1 or other system information by the NR cell, a height threshold value indicating whether the UAV UE 1f-01 applies the cellBarred-UAV and/or intraFreqReselction-UAV. According to an embodiment of the disclosure, when the height of the UAV UE 1f-01 is equal to or greater than the height threshold value, the UAV UE 1f-01 may apply the cellBarred-UAV and/or intraFreqReselection-UAV.

In operation 1f-15, the UAV UE 1f-01 in the RRC idle mode or the RRC inactive state may perform, based on the essential system information acquired in operation 1f-10, a cell selection procedure. For example, the UAV UE 1f-01 in the RRC idle mode or the RRC inactive state may search for an NR suitable cell belonging to a selected PLMN or SNPN to perform camp-on on the corresponding cell. The cell on which the UAV UE 1f-01 in the RRC idle mode or the RRC inactive state performs camp-on may be referred to as a serving cell. In the disclosure, the cell may be defined as a suitable cell when the conditions in Table 1 below are fulfilled based on the 3GPP standard document “38.304: User Equipment (UE) procedures in Idle mode and RRC Inactive state”. In operation 1f-15, the UAV UE 1f-01 in the RRC idle mode or the RRC inactive state may select a cell or reselect a cell by applying the cellBarred-UAV broadcasted in SIB1 or other system information when i) flight is performed at the height higher than the height threshold value broadcasted via the system information, or ii) flight is performed at the same height as the height threshold value. When the UAV UE flies at the height lower than the height threshold value broadcasted via the system information, the UAV UE may select or reselect a cell by applying the conventional parameter (cellBarred in MIB) broadcasted in the MIB. According to an embodiment of the disclosure, when the UAV UE flies at the height equal to or lower than the height threshold value, the UAV UE may select or reselect a cell by applying the conventional parameter (cellBarred in MIB) broadcasted via the MIB. The UE operation of selecting or reselecting the cell may follow the above-described embodiment. For reference, the height threshold value may be broadcasted via the system information or may be determined in the UE by itself. When the height threshold value is determined in the UE by itself, it may mean that the UE itself may determine the height threshold value and determine whether to apply a new parameter (cellBarred-UAV). For reference, when the cellBarred indicator is set to “barred” in the MIB, the UAV UE may ignore the same and determine whether to select or reselect a cell according to the cellBarred-UAV. In a case of where the UE is not the UAV UE or a case where applying new parameters is not supported according to the flying height, access to the corresponding cell may fail. According to an embodiment of the disclosure, when the cellBarred indicator in the MIB is “barred”, access to the corresponding cell may fail. According to an embodiment of the disclosure, in the SIB1, when cellReservedForOperatorUse is reserved, cellReservedForOtherUse is true, or cellReservedForFutureUse is true, access to the corresponding cell may fail.

In operation 1f-20, when flying at the height higher than the height threshold value broadcasted in the system information, the UAV UE 1f-01 in the RRC idle mode or the RRC inactive state may reselect neighboring cells using the same frequency as the NR cell 1f-02. According to an embodiment of the disclosure, in operation 1f-20, when flying at the height equal to the height threshold value, the UAV UE 1f-01 in the RRC idle mode or the RRC inactive state may reselect neighboring cells using the same frequency as the NR cell 1f-02. According to an embodiment of the disclosure, in operation 1f-20, when the intraFreqReselection-UAV is indicated as “allowed” in the SIB1 or other system information, the UAV UE 1f-01 may reselect neighboring cells using the same frequency as the NR cell 1f-02. When the intraFreqReselection-UAV is indicated as “nonallowed”, the UAV UE 1f-01 in the RRC idle mode or the RRC inactive state cannot reselect neighboring cells using the same frequency as the NR cell 1f-02 for 300 seconds. When flying at the height lower than the height threshold value broadcasted in the system information, the UAV UE 1f-01 in the RRC idle mode or the RRC inactive state may determine intra frequency cell reselection according to the conventional parameter (intraFreqReselection). According to an embodiment of the disclosure, when flying at the height equal to or lower than the height threshold value broadcasted in the system information, the UAV UE 1f-01 in the RRC idle mode or the RRC inactive state may determine intra frequency cell reselection according to the conventional parameter (intraFreqReselection).

The disclosure proposes when the height at which the UAV UE flies is equal to or greater than the height threshold value, applying a parameter of new cell reservations and access restrictions that are newly proposed (for example, cellBarred-UAV and/or intraFreqReselection-UAV in SIB), instead of applying a parameter of the conventional cell reservations and access restrictions in the MIB and SIB1 (cellBarred and/or intraFreqReselection in MIB).

FIG. 1G illustrates a method for accessing a cell by an uncrewed aerial vehicle (UAV) UE in a wireless communication system according to an embodiment of the disclosure.

The UAV UE may have a feature enabling a probability of a higher line of sight than that of a terrestrial UE. Therefore, compared to the terrestrial UE, the UAV UE may have a disadvantage of receiving downlink (hereinafter, referred to as DL) interference from more cells. That is, the UAV UE may receive a higher level of DL interference from more neighboring cells than those of the terrestrial UE. Similarly, the UAV UE may cause uplink (hereinafter, referred to as UL) interference to more cells than the terrestrial UE. A barring method according to the feature of the UAV UE is proposed in the disclosure

Referring to FIG. 1g, in operation 1g-05, a UAV UE 1g-01 may be in an RRC idle mode (RRC_IDLE) or an RRC inactive mode (RRC_INACTIVE) since no RRC connection with an NR cell 1g-02 is configured.

In operation 1g-10, the UAV UE 1g-01 in the RRC idle mode or the RRC inactive state may acquire essential system information and other system information (SIB2, SIB3, etc.) from the NR cell 1g-02. In the disclosure, a master information block (MIB) and system information block 1 (SIB1) may be referred to as essential system information. New parameters broadcasted in SIB1 or other system information may follow the above-described embodiments. Additionally, in the disclosure, an indicator indicating whether to apply new parameters according to the UAV UE or apply new parameters according to the height at which the UE flies may be broadcasted. Specifically, when it is indicated to apply new parameters according to the UAV UE, the UAV UE may apply new parameters according to FIG. 1E, and when it is indicated to apply new parameters according to the height at which the UE flies, the UAV UE may apply new parameters according to FIG. 1F.

In operation 1g-15, the UAV UE 1g-01 in the RRC idle mode or the RRC inactive state may perform, based on the essential system information acquired in operation 1g-10, a cell selection procedure. According to an embodiment of the disclosure, when SIB1 indicates to apply new parameters according to the UAV UE, the UAV UE 1g-01 in the RRC idle mode or the RRC inactive state may apply new parameters according to FIG. 1E. In addition, according to an embodiment of the disclosure, when SIB1 indicates to apply new parameters according to the height of flying, the UAV UE 1g-01 in the RRC idle mode or the RRC inactive state may apply new parameters according to FIG. 1F.

In operation 1g-20, when SIB1 or other system information indicates to apply new parameters according to the UAV UE, the UAV UE may perform intra-frequency cell reselection by applying new parameters according to FIG. 1E. In addition, in operation 1g-20, when SIB1 or other system information indicates to apply new parameters according the height of flying, the UAV UE may perform intra-frequency cell reselection by applying new parameters according to FIG. 1F.

In the disclosure, the NR cell controls whether to apply, according to the UAV UE type or the height of flying, parameters of new cell reservations and access restrictions (for example, cellBarred-UAV and/or intraFreqReselection-UAV in SIB) that are newly proposed.

FIG. 1H illustrates a process of performing UE access control in a wireless communication system according to an embodiment of the disclosure.

The disclosure proposes an access identity and an access category dedicated for an uncrewed aerial vehicle (UAV) UE or a UE capable of flying, and proposes performing a barring check operation of determining whether wireless access is allowed by providing new access control configuration information by a UE AS according the access identity and access category.

The access identity is indication information defined in the 3GPP, i.e., specified in the standard document. The access identity is used to indicate a specific access as in the table below. The disclosure proposes a new access identity. According to an embodiment of the disclosure, the new access identity may mean an access identity applied to the UAV UE, or may mean an access identity applied to a UE capable of flying when the height at which the UE capable of flying is equal to or greater than a specific height threshold. The new access identity may mean one of 3 to 10 in Table 2 below.

TABLE 2

| Access | |
|---|---|
| Identity number | UE configuration |
| 0 | UE is not configured with any parameters from this |
| | table |
| 1 (NOTE | UE is configured for Multimedia Priority Service |
| 1) | (MPS). |
| 2 (NOTE | UE is configured for Mission Critical Service |
| 2) | (MCS). |
| 3-10 | Reserved for future use |
| 11 | Access Class 11 is configured in the UE. |
| (NOTE 3) | |
| 12 | Access Class 12 is configured in the UE. |
| (NOTE 3) | |
| 13 | Access Class 13 is configured in the UE. |
| (NOTE 3) | |
| 14 | Access Class 14 is configured in the UE. |
| (NOTE 3) | |
| 15 | Access Class 15 is configured in the UE. |
| (NOTE 3) | |

NOTE 1:
Access Identity 1 is used to provide overrides according to the subscription information in UEs configured for MPS. The subscription information defines whether an override applies to UEs within one of the following categories: a) UEs that are configured for MPS; b) UEs that are configured for MPS and are in the PLMN listed as most preferred PLMN of the country where the UE is roaming in the operator-defined PLMN selector list or in their HPLMN or in a PLMN that is equivalent to their HPLMN; c) UEs that are configured for MPS and are in their HPLMN or in a PLMN that is equivalent to it.
NOTE 2:
Access Identity 2 is used to provide overrides according to the subscription information in UEs configured for MCS. The subscription information defines whether an override applies to UEs within one of the following categories: a) UEs that are configured for MCS; b) UEs that are configured for MCS and are in the PLMN listed as most preferred PLMN of the country where the UE is roaming in the operator-defined PLMN selector list or in their HPLMN or in a PLMN that is equivalent to their HPLMN; c) UEs that are configured for MCS and are in their HPLMN or in a PLMN that is equivalent to it.
NOTE 3:
Access Identities 11 and 15 are valid in Home PLMN only if the EHPLMN list is not present or in any EHPLMN. Access Identities 12, 13 and 14 are valid in Home PLMN and visited PLMNs of home country only. For this purpose, the home country is defined as the country of the MCC part of the IMSI.

The access category is divided into two types. One type is a standardized access category. The standardized access category is a category defined at the level of a RAN, i.e., a category specified in the standard document. Accordingly, different operators apply the same standardized access category. All accesses correspond to at least one of standardized access categories. The other type is an operator-specific (non-standardized) access category. The operator-specific (non-standardized) access category is defined outside the 3GPP, and is not specified in the standard document. Accordingly, what is meant by one operator-specific access category may vary according to an operator. This feature is identical to that of the category in the existing ACDC. An access triggered in a UE NAS may not be mapped to the operator-specific (non-standardized) access category. A big difference from the existing ACDC is that the operator-specific (non-standardized) access category corresponds to not only an application but also elements other than the application, i.e., a service type, a call type, a UE type, a user group, a signaling type, a slice type, or a combination of elements other than the application. That is, whether to access approval for accesses belonging to other elements may be controlled. The access category is used to indicate a specific access as in the table below. Access categories 0 to 7 are used to indicate standardized access categories, and access categories 32 to 63 are used to indicate operator-specific access categories. The disclosure proposes a new standardized access category. According to an embodiment of the disclosure, the new standardized access category may mean a standardized access category applied to the UAV UE, or may mean a standardized access category applied to a UE capable of flying when the height of the UE capable of flying is equal to or greater than a specific height threshold. The new standardized access category may mean one of categories 8-31 in Table 3 below.

TABLE 3

| Access | | |
|---|---|---|
| Category | Conditions related to | Type of access |
| number | UE | attempt |
| 0 | All | MO signalling |
| | | resulting from paging |
| 1 | UE is configured for | All except for |
| (NOTE 1) | delay tolerant service and subject | Emergency |
| | to access control for Access | |
| | Category 1, which is judged | |
| | based on relation of UE's | |
| | HPLMN and the selected | |
| | PLMN. | |
| 2 | All | Emergency |
| 3 | All except for the | MO signalling |
| | conditions in Access Category 1. | resulting from other than |
| | | paging |
| 4 | All except for the | MMTEL voice |
| | conditions in Access Category 1. | |
| 5 | All except for the | MMTEL video |
| | conditions in Access Category 1. | |
| 6 | All except for the | SMS |
| | conditions in Access Category 1. | |
| 7 | All except for the | MO data that do |
| | conditions in Access Category 1. | not belong to any other |
| | | Access Categories |
| 8-31 | | Reserved |
| | | standardized Access |
| | | Categories |
| 32-63 | All | Based on operator |
| (NOTE 2) | | classification |

NOTE 1:
The barring parameter for Access Category 1 is accompanied with information that define whether Access Category applies to UEs within one of the following categories: a) UEs that are configured for delay tolerant service; b) UEs that are configured for delay tolerant service and are neither in their HPLMN nor in a PLMN that is equivalent to it; c) UEs that are configured for delay tolerant service and are neither in the PLMN listed as most preferred PLMN of the country where the UE is roaming in the operator-defined PLMN selector list on the SIM/USIM, nor in their HPLMN nor in a PLMN that is equivalent to their HPLMN.
NOTE 2:
When there are an Access Category based on operator classification and a standardized Access Category to both of which an access attempt can be categorized, and the standardized Access Category is neither 0 nor 2, the UE applies the Access Category based on operator classification. When there are an Access Category based on operator classification and a standardized Access Category to both of which an access attempt can be categorized, and the standardized Access Category is 0 or 2, the UE applies the standardized Access Category.

An operator server 1h-25 provides the UE NAS with information (a management object (MO)) on operator-specific access category information through NAS signaling or application level data transmission. The information (management object (MO)) indicates an element such as an application to which each operator-specific category corresponds. For example, access category 32 corresponding to access corresponding to a Facebook application may be specified in the information (management object (MO)). A base station 1h-20 provides, by using system information, UEs with barring configuration information corresponding to each category and a category list of providing the barring configuration information. A UE 1h-05 includes logical blocks of a NAS 1h-10 and an AS 1h-15.

The UE NAS maps triggered access to one or more access identities and one access category according to a predetermined rule. The mapping operation is performed in all RRC states, i.e., a connected mode (RRC_CONNECTED), a standby mode (RRC_IDLE), and an inactive mode (RRC_INACTIVE). The characteristic of each RRC state is enumerated as follows.

### RRC_IDLE:

A UE specific DRX may be configured by upper layers;
UE controlled mobility based on network configuration;
The UE:
Monitors a Paging channel;
Performs neighboring cell measurements and cell (re-) selection;
Acquires system information.

### RRC_INACTIVE:

A UE specific DRX may be configured by upper layers or by RRC
layer;
UE controlled mobility based on network configuration;
The UE stores the AS context;
The UE:
Monitors a Paging channel;
Performs neighboring cell measurements and cell (re-) selection;
Performs RAN-based notification area updates when moving outside the RAN-based notification area;
Acquires system information.

### RRC_CONNECTED:

The UE stores the AS context.
Transfer of unicast data to/from UE.
At lower layers, the UE may be configured with a UE specific DRX;
For UEs supporting CA, use of one or more SCells, aggregated with the SpCell, for increased bandwidth;
For UEs supporting DC, use of one SCG, aggregated with the MCG, for increased bandwidth;
Network controlled mobility, i.e. handover within NR and to/from E-UTRAN.
The UE:
Monitors a Paging channel;
Monitors control channels associated with the shared data channel to determine if data is scheduled for it;
Provides channel quality and feedback information;
Performs neighboring cell measurements and measurement reporting;
Acquires system information.

In other option, in access category mapping, if one access can be mapped to one standardized access category, additionally, mapping to one operator-specific access category can be mapped. The UE NAS transfers, to the UE AS, the access identity and the access category mapped with a service request.

When the UE AS receives the access identity or access category information with a message received from the UE NAS in all RRC states, a barring check operation of determining whether wireless access is allowed before the wireless access caused due to the message is performed. When the wireless access is allowed through the barring check operation, an RRC connection configuration is requested from a network. According to an embodiment of the disclosure, the UE NAS in the connected mode or inactive mode transmits the access identity and the access category to the UE AS due to the reasons below (operation 1h-30). In the disclosure, the reasons below are collectively called a “new session request”.
new MMTEL voice or video session
sending of SMS (SMS over IP, or SMS over NAS)
new PDU session establishment
existing PDU session modification
service request to re-establish the user plane for an existing PDU session

On the other hand, during the service request, the NAS of the UE in the standby mode transmits the access identity and the access category to the UE AS. According to an embodiment of the disclosure, a new access identity proposed in the disclosure may be mapped to the conventional access category. According to an embodiment of the disclosure, a new access category proposed in the disclosure may be mapped to the conventional access identity. According to an embodiment of the disclosure, a new access identity proposed in the disclosure may be mapped to a new access category.

The UE AS determines whether the access triggered by the UE NAS is allowed using the barring configuration information (barring check).

FIG. 1I is a flow chart of a process of performing access control of the conventional UE in a wireless communication system according to an embodiment.

A UE 1i-05 includes an NAS 1i-10 and an AS 1i-15. The NAS performs processes having no direct wireless access, i.e., authentication, service request, and session management, and the AS performs processes related to the wireless access. A network provides management object information to the NAS by using an OAM (a data message at the level of application) or a NAS message (operation 1i-25). The management object information indicates an element such as an application to which each operator-specific access category corresponds. The NAS uses management object information to determine an operator-specific category to which the triggered access is mapped. The triggered access corresponds to a new MMTEL service (voice call or video call), SMS transmission, new PDU session establishment, an existing PDU session change, etc. When the service is triggered, the NAS maps the same to the access identity and the access category corresponding to the attribute of the service (operation 1i-30). The service may not be mapped to any access identity, and may be mapped to one or more access identities. In addition, the service may be mapped to one access category. In the assumption that the service can be mapped to one access category, whether the service is mapped to the operator-specific access category provided by the measurement object is first identified. If the service is not mapped to any operator-specific access category, the service is mapped to corresponding one among standardized access categories. In the assumption that the service can be mapped to multiple access categories, one service is mapped to one operator-specific access category and one standardized access category. However, if the service is not mapped to any operator-specific access category, the service is mapped corresponding one among the standardized access categories. In the mapping rule, an emergency service may be an exception. The NAS transmits the new session request or service request to the AS, together with the mapped access identity and access category (operation 1i-40). The NAS transmits the new session request in the connected mode or the inactive mode, and transmits the service request in the standby mode. The AS receives barring configuration information from system information broadcasted via a network (operation 1i-35). The example of the ASN.1 structure of the barring configuration information is as in Table 4 below, and a detailed description thereof is made below.

TABLE 4

| | |
|---|---|
| UAC-BarringPerPLMN-List ::= | SEQUENCE (SIZE (1.. |

maxPLMN)) OF UAC-BarringPerPLMN

| | |
|---|---|
| UAC-BarringPerPLMN ::= | SEQUENCE { |
| plmn-IdentityIndex | INTEGER (1..maxPLMN), |
| uac-ACBarringListType | CHOICE{ |
| uac-ImplicitACBarringList | SEQUENCE |

(SIZE(maxAccessCat-1)) OF UAC-BarringInfoSetIndex,

| | |
|---|---|
| uac-ExplicitACBarringList | UAC-BarringPerCatList |

```
      }
  }
  UAC-BarringPerCatList ::= SEQUENCE (SIZE (1..maxAccessCat-1)) OF
UAC-BarringPerCat
  UAC-BarringPerCat ::= SEQUENCE {
```

| | |
|---|---|
| accessCategory | INTEGER (1..maxAccessCat-1), |
| uac-barringInfoSetIndex | UAC-BarringInfoSetIndex |

}

| | |
|---|---|
| UAC-BarringInfoSetIndex ::= | INTEGER |

```
(1..maxBarringInfoSet)
  UAC-BarringInfoSetList ::= SEQUENCE (SIZE(1..maxBarringInfoSet))
OF UAC-BarringInfoSet
  UAC-BarringInfoSet ::= SEQUENCE {
  uac-BarringFactor ENUMERATED {
```

| | |
|---|---|
| | p00, p05, p10, p15, p20, p25, p30, p40, |
| | p50, p60, p70, p75, p80, p85, p90, p95}, |
| uac-BarringTime | ENUMERATED {s4, s8, s16, s32, s64, |

s128, s256, s512},

| | |
|---|---|
| uac-BarringForAccessIdentity | BIT STRING (SIZE(7)) |

}

The AS determines, using corresponding barring configuration information received from the network and the access identity and access category information mapped by the NAS, whether a service request is allowed (operation 1i-45). In the disclosure, an operation of determining whether the service request is allowed is called barring check. The UE receives system information including access control configuration information and stores barring configuration information. The barring configuration information is provided for each PLMN and each access category. A BarringPerCatList information element (IE) is used to provide barring configuration information of access categories belonging to one PLMN. To this end, a PLMN id and barring configuration information of each access category are included in a BarringPerCatList IE in the form of a list. The access category-specific barring configuration information includes an access category id (or index) indicating a specific access category, a uac-BarringForAccessIdentity field, a uac-BarringFactor field, and a uac-Barringtime field. The barring check operation is as follows. First, respective bits constituting the uac-BarringForAccessIdentityList correspond to one access identity, and access related to the access identity is allowed when a bit value is indicated to be “0”. For at least one of the mapped access identities, when at least one of corresponding bits in the uac-BarringForAccessIdentity is “0”, the access is allowed. For at least one of the mapped access identities, if any of the corresponding bits in the uac-BarringForAccessIdentity is not “0”, the UE AS performs additional barring checked described below by using the uac-BarringFactor field. The range of uac-BarringFactor α is 0≤α<1. The UE AS derives one random value rand corresponding to 0≤rand <1, and it is considered that if one random value rand is smaller than uac-BarringFactor, access is not prohibited, and if not, access is prohibited. When it is determined that the access is prohibited, the UE AS delays access attempt for a predetermined time derived using Equation 2 below. The UE AS drives a timer having a time value. In the disclosure, the timer is called a barring timer.

$$“ Tbarring ” = ( 0.7 + 0.6 * rand ) * uac - BarringTime . \qquad [ Equation 2 ]$$

When the access is prohibited, the UE AS notifies the UE NAS of the same. When the derived predetermined time expires, the UE AS notifies, to the UE NAS, that the access can be requested again (barring alleviation). From this time, the UE NAS may request the access from the UE AS again.

According to a predetermined rule, when the service request is allowed, the AS requests RRC connection establishment (or RRC connection resume) from the network or transmits new session-related data to the network (operation 1i-50).

FIG. 1J is a flow chart of a process of performing access control in a wireless communication system according to an embodiment of the disclosure.

A UAV UE 1j-05 includes an NAS 1j-10 and an AS 1j-15. The NAS performs processes having no direct wireless access, i.e., authentication, service request, and session management, and the AS performs processes related to the wireless access. A network 1j-20 provides management object information to the NAS by using an OAM (a data message at the level of application) or a NAS message (operation 1j-25). The management object information indicates an element such as an application to which each operator-specific access category corresponds. The NAS uses management object information to determine an operator-specific category to which the triggered access is mapped. The triggered access corresponds to a new MMTEL service (voice call or video call), SMS transmission, new PDU session establishment, an existing PDU session change, etc. When the service is triggered, the NAS maps the same to the access identity and the access category corresponding to the attribute of the service (operation 1j-30). The service may not be mapped to any access identity, and may be mapped to one or more access identities. In addition, the service may be mapped to one access category. In the assumption that the service can be mapped to one access category, whether the service is mapped to the operator-specific access category provided by the measurement object is first identified. If the service is not mapped to any operator-specific access category, the service is mapped to corresponding one among standardized access categories. In the assumption that the service can be mapped to multiple access categories, one service is mapped to one operator-specific access category and one standardized access category. However, if the service is not mapped to any operator-specific access category, the service is mapped corresponding one among the standardized access categories. In the mapping rule, an emergency service may be an exception. The NAS transmits the new session request or service request to the AS, together with the mapped access identity and access category (operation 1j-40). The NAS transmits the new session request in the connected mode or the inactive mode, and transmits the service request in the standby mode. As in the above-described embodiment, the AS receives barring configuration information from system information broadcasted via a network (operation 1j-35). The disclosure proposes broadcasting, via system information, a new access category (for example, a new access category mapped to a UAC service) applicable to the UAV UE, a new access identity (for example, a new access identity mapped to the UAC service), and new barring configuration information thereof. Specifically, the information may have one of the following meanings.
The new access category may mean one of 8 to 31.
The new access identity may mean one of 3 to 10.
The new barring configuration information may be broadcasted in one of the following methods.
   Method 1: New barring configuration information
      The conventional or new access identity mapped to the conventional or new access category may mean at least one of the following pieces of new barring configuration information.
         uac-BarringFactorUAV: may be broadcasted as one value of the range of 0≤uac-BarringFactorUAV<1. For example, the uac-BarringFactorUAV may be broadcasted as one among 0, 0.05, 0.1, 0.15, 0.2, 0.25, 0.3, 0.4, 0.5, 0.6, 0.7, 0.75, 0.8, 0.85, 0.9, and 0.95.
         uac-BarringTimeUAV: indicates an average time until a new access attempt is performed after the access attempt is barred, and may be broadcasted as one of values in units of seconds. For example, the uac-Barring TimeUAV may be broadcasted as one among 4 s, 8 s, 16 s, 32 s, 64 s, 128 s, 256 s, and 512 s.
   Method 2: New barring scaling configuration information
      The conventional or new access identity mapped to the conventional or new access category may mean at least one of the following pieces of new barring scaling configuration information.
         uac-ScalingBarringFactorUAV: The UE may determine whether access is prohibited by adding uac-ScalingBarringFactorUAV to the conventional uac-BarrringFactor and multiplying the conventional uac-BarrringFactor and the uac-ScalingBarringFactorUAV.

$$■ uac - BarringFactorUAV = uac - BarringFactor + uac - ScalingBarringFactorUAV or uac - BarringFactor * uac - ScalingBarringFactorUAV$$

uac-ScalingBarringTime: is used when deriving Tbarring, and a barring timer may be derived by adding uac-ScalingBarringTime to uac-BarringTime and multiplying the uac-BarringTime and the uac-ScalingBarring Time.

$$■ Uac - BarringTimeUAV = uac - BarringTime + uac - ScalingBarringTime or uac - BarringTime * uac - ScalingBarringTime$$

The AS determines, using corresponding barring configuration information received from the network and the access identity and access category information mapped by the NAS, whether a service request is allowed (operation 1j-45). In the disclosure, an operation of determining whether the service request is allowed is called barring check. The UAV UE receives system information including access control configuration information and stores access control configuration information. The barring configuration information is provided for each public land mobile network (PLMN) and each access category. A BarringPerCatList information element (IE) is used to provide barring configuration information of access categories belonging to one PLMN. To this end, a PLMN id and barring configuration information of each access category are included in a BarringPerCatList IE in the form of a list. The access category-specific barring configuration information includes an access category id (or index) indicating a specific access category, a uac-BarringForAccessIdentity field, a uac-BarringFactor field, and a uac-Barringtime field. The barring check operation is as follows. First, respective bits constituting the uac-BarringForAccessIdentityList correspond to one access identity, and access related to the access identity is allowed when a bit value is indicated to be “0”. For at least one of the mapped access identities, when at least one of corresponding bits in the uac-BarringForAccessIdentity is “0”, the access is allowed. For at least one of the mapped access identities, if any of the corresponding bits in the uac-BarringForAccessIdentity is not “0”, the UE AS performs additional barring checked described below by using the uac-BarringFactorUAV field. The range of uac-BarringFactor α is 0≤α<1. The UE AS derives one random value rand corresponding to 0≤rand <1, and it is considered that if one random value rand is smaller than uac-BarringFactorUAV, access is not prohibited, and if not, access is prohibited. When it is determined that the access is prohibited, the UE AS delays access attempt for a predetermined time derived using Equation 3 below. The UE AS drives a timer having a time value. In the disclosure, the timer is called a barring timer.

$$“ Tbarring ” = ( 0.7 + 0.6 * rand ) * uac - BarringTimeUAV \qquad [ Equation 3 ]$$

When the access is prohibited, the UE AS notifies the UE NAS of the same. When the derived predetermined time expires, the UE AS notifies, to the UE NAS, that the access can be requested again (barring alleviation). From this time, the UE NAS may request the access from the UE AS again.

According to a predetermined rule, when the service request is allowed, the AS requests RRC connection establishment (or RRC connection resume) from the network or transmits new session-related data to the network (operation 1j-50).

In the disclosure, in a case of a UAV UE, when new access category information, new access identity information, and new barring configuration information for the UAV UE are broadcasted in system information, the UAV UE may apply the same to check barring. Even in a case of the UAV UE, when the new access category information, new access identity information, and new barring configuration information are not broadcasted in the system information, barring can be checked according to the above-described embodiment.

FIG. 1K is a flow chart of a process of performing access control in a wireless communication system according to an embodiment of the disclosure.

A UAV UE 1k-05 includes an NAS 1k-10 and an AS 1k-15. The NAS performs processes having no direct wireless access, i.e., authentication, service request, and session management, and the AS performs processes related to the wireless access. A network 1k-20 provides management object information to the NAS by using an OAM (a data message at the level of application) or a NAS message (operation 1k-25). The management object information indicates an element such as an application to which each operator-specific access category corresponds. The NAS uses management object information to determine an operator-specific category to which the triggered access is mapped. The triggered access corresponds to a new MMTEL service (voice call or video call), SMS transmission, new PDU session establishment, an existing PDU session change, etc. When the service is triggered, the NAS maps the same to the access identity and the access category corresponding to the attribute of the service (operation 1k-30). The service may not be mapped to any access identity, and may be mapped to one or more access identities. In addition, the service may be mapped to one access category. In the assumption that the service can be mapped to one access category, whether the service is mapped to the operator-specific access category provided by the measurement object is first identified. If the service is not mapped to any operator-specific access category, the service is mapped to corresponding one among standardized access categories. In the assumption that the service can be mapped to multiple access categories, one service is mapped to one operator-specific access category and one standardized access category. However, if the service is not mapped to any operator-specific access category, the service is mapped corresponding one among the standardized access categories. In the mapping rule, an emergency service may be an exception. The NAS transmits the new session request or service request to the AS, together with the mapped access identity and access category (operation 1k-40). The NAS transmits the new session request in the connected mode or the inactive mode, and transmits the service request in the standby mode. As in the above-described embodiment, the AS receives barring configuration information from system information broadcasted via a network (operation 1k-35). The disclosure proposes broadcasting, via system information, a new access category (for example, a new access category mapped to a UAC service) applicable to the UAV UE flying at the height equal to or greater than a height threshold value, a new access identity (for example, a new access identity mapped to the UAC service), and new barring configuration information thereof. For example, if the height at which the UAV UE flies is equal to or greater than a height threshold value, the UAV UE may apply new barring configuration information, and if not, the UAV UE may apply the conventional barring configuration information. The height threshold value may be broadcasted via system information, or may be determined in the UAV UE itself. The new information may have at least one of the following meanings.
The new access category may mean one of 8 to 31.
The new access identity may mean one of 3 to 10.
The new barring configuration information may be broadcasted in one of the following methods.
   Method 1: New barring configuration information
      The conventional or new access identity mapped to the conventional or new access category may mean at least one of the following pieces of new barring configuration information
         uac-BarringFactorUAV: may be broadcasted as one value of the range of 0≤uac-BarringFactorUAV<1. For example, the uac-BarringFactorUAV may be broadcasted as one among 0, 0.05, 0.1, 0.15, 0.2, 0.25, 0.3, 0.4, 0.5, 0.6, 0.7, 0.75, 0.8, 0.85, 0.9, and 0.95.
         uac-BarringTimeUAV: indicates an average time until a new access attempt is performed after the access attempt is barred, and may be broadcasted as one of values in units of seconds. For example, the uac-BarringTimeUAV may be broadcasted as one among 4 s, 8 s, 16 s, 32 s, 64 s, 128 s, 256 s, and 512 s.
   Method 2: New barring scaling configuration information
      The conventional or new access identity mapped to the conventional or new access category may mean at least one of the following pieces of new barring scaling configuration information.
         uac-ScalingBarringFactorUAV: The UE may determine whether access is prohibited by adding uac-ScalingBarringFactorUAV to the conventional uac-BarrringFactor and multiplying the conventional uac-BarrringFactor and the uac-ScalingBarringFactorUAV.

$$■ uac - BarringFactorUAV = uac - BarringFactor + uac - ScalingBarringFactorUAV or uac - BarringFactor * uac - ScalingBarringFactorUAV$$

uac-ScalingBarringTime: is used when deriving Tbarring, and a barring timer may be derived by adding uac-ScalingBarringTime to uac-BarringTime and multiplying the uac-BarringTime and the uac-ScalingBarring Time.

$$■ Uac - BarringTimeUAV = uac - BarringTime + uac - ScalingBarringTime or uac - BarringTime * uac - ScalingBarringTime$$

The AS determines, using corresponding barring configuration information received from the network and the access identity and access category information mapped by the NAS, whether a service request is allowed (operation 1k-45). In the disclosure, an operation of determining whether the service request is allowed is called barring check. In the disclosure, an operation of performing barring check by the UE AS according to new barring configuration information when the UAV UE files at the height equal to or greater than a height threshold value. The UAV UE receives system information including access control configuration information and stores access control configuration information. The barring configuration information is provided for each public land mobile network (PLMN) and each access category. A BarringPerCatList information element (IE) is used to provide barring configuration information of access categories belonging to one PLMN. To this end, a PLMN id and barring configuration information of each access category are included in a BarringPerCatList IE in the form of a list. The access category-specific barring configuration information includes an access category id (or index) indicating a specific access category, a uac-BarringForAccessIdentity field, a uac-BarringFactor field, and a uac-Barringtime field. The barring check operation is as follows. First, respective bits constituting the uac-BarringForAccessIdentityList correspond to one access identity, and access related to the access identity is allowed when a bit value is indicated to be “0”. For at least one of the mapped access identities, when at least one of corresponding bits in the uac-BarringForAccessIdentity is “0”, the access is allowed. For at least one of the mapped access identities, if any of the corresponding bits in the uac-BarringForAccessIdentity is not “0”, the UE AS performs additional barring checked described below by using the uac-BarringFactorUAV field. The range of uac-BarringFactorUAV a is 0≤α<1. The UE AS derives one random value rand corresponding to 0≤rand <1, and it is considered that if one random value rand is smaller than uac-BarringFactor, access is not prohibited, and if not, access is prohibited. When it is determined that the access is prohibited, the UE AS delays access attempt for a predetermined time derived using Equation 3 below. The UE AS drives a timer having a time value. In the disclosure, the timer is called a barring timer.

When the access is prohibited, the UE AS notifies the UE NAS of the same. When the derived predetermined time expires, the UE AS notifies, to the UE NAS, that the access can be requested again (barring alleviation). From this time, the UE NAS may request the access from the UE AS again.

According to a predetermined rule, when the service request is allowed, the AS requests RRC connection establishment (or RRC connection resume) from the network or transmits new session-related data to the network (operation 1k-50).

In the disclosure, the UAC UE may fly at the height equal to or greater than a height threshold value and perform access control according to new configuration information. When the UAC UE flies at the height lower than the height threshold value, access control may be performed according to the conventional configuration information. According to an embodiment of the disclosure, when the UAC UE flies at the height lower than the height threshold value or flies at the height equal to the height threshold value, access control may be performed according to the conventional configuration information.

FIG. 1L illustrates configuring new physical random access channel (PRACH) parameters prioritization for a UAV UE by an NR base station in a wireless communication system according to an embodiment of the disclosure.

Referring to FIG. 1L, a UAV UE 1l-01 may be in an RRC idle mode (RRC_IDLE) or an RRC inactive mode (RRC_INACTIVE) without configuring an RRC connection with an NR base station 1l-20 (operation 1l-05). Alternatively, the UAV UE 1l-01 may be in an RRC-connected mode by configuring the RRC connection with the NR base station 1l-02 (operation 1l-05).

In operation 1l-10, the UAV UE 1l-01 may receive new PRACH prioritization parameters from the NR base station 1l-02. In the disclosure, the new PRACH prioritization parameters may have at least one of the following meanings.
scalingFactorBIUAV: is a scaling factor used when performing a prioritized random access procedure.
powerRamingStepHighPriorityUAV: is a power ramping factor used when performing a prioritized random access procedure.

For reference, the NR base station 1l-02 may provide the new PRACH prioritization parameters to the UAV UE via system information or dedicated RRC signaling. For reference, the new PRACH parameters prioritization may be used for the UE for which beam failure recovery, handover, mission critical service (MCS)/mission priority service (MPS), and new UAV access identity are configured. The new PRACH parameters prioritization may be used for both 2 step random access and 4 step random access procedures.

In operation 1l-15, the UAV UE 1l-01 may apply the new PRACH prioritization parameters received from the NR base station 1l-02.

In operation 1l-20, the UAV UE 1l-01 may initiate a prioritized random access procedure with the NR base station 1l-02 by applying the new PRACH prioritization parameters.

FIG. 1M is a block diagram illustrating an internal structure of a UE in a wireless communication system according to an embodiment of the disclosure.

Referring to FIG. 1M, the UE may include a radio frequency (RF) processor 1m-10, a baseband processor 1m-20, a storage 1m-30, and a controller 1m-40.

The RF processor 1m-10 performs a function for transmitting or receiving a signal via a wireless channel, such as band conversion and amplification of the signal. That is, the RF processor 1m-10 up-converts a baseband signal provided from the baseband processor 1m-20 into an RF band signal and then transmits the same through an antenna, and down-converts an RF band signal received through the antenna to a baseband signal. For example, the RF processor 1m-10 may include a transmission filter, a reception filter, an amplifier, a mixer, an oscillator, a digital-to-analog converter (DAC), an analog-to-digital converter (ADC), etc. FIG. 1M illustrates only one antenna, but the UE may include multiple antennas. In addition, the RF processor 1m-10 may include multiple RF chains. Furthermore, the RF processor 1m-10 may perform beamforming. For the beamforming, the RF processor 1m-10 may adjust the phase and magnitude of each of signals transmitted or received through multiple antennas or antenna elements. In addition, the RF processor may perform MIMO, and may receive multiple layers when performing MIMO operations.

The baseband processor 1m-20 performs a function of conversion between a baseband signal and a bit stream according to the physical layer standard of a system. For example, during data transmission, the baseband processor 1m-20 generates complex symbols by coding and modulating a transmission bit stream. In addition, upon receiving data, the baseband processor 1m-20 restores the received bit stream through demodulation and decoding of the baseband signal provided from the RF processor 1m-10. For example, in the case of conforming to an OFDM method, when transmitting data, the baseband processor 1m-20 performs coding and modulation of a transmission bit stream to generate complex symbols, maps the complex symbols to subcarriers, and then configures OFDM symbols via an inverse fast Fourier transform (IFFT) operation and cyclic prefix (CP) insertion. In addition, when receiving data, the baseband processor 1m-20 divides the baseband signal provided from the RF processor 1m-10 into units of OFDM symbols, restores signals mapped to subcarriers via the fast Fourier transform (FFT) operation, and then restores a received bit stream via demodulation and decoding.

The baseband processor 1m-20 and the RF processor 1m-10 transmits and receives signals as described above. Accordingly, each of the baseband processor 1m-20 and the RF processor 1m-10 may be referred to as a transmitter, a receiver, a transceiver, or a commutation unit. Furthermore, at least one of the baseband processor 1m-20 and the RF processor 1m-10 may include multiple communication modules to support different multiple radio access technologies. In addition, at least one of the baseband processor 1m-20 and the RF processor 1m-10 may include different communication modules to process signals in different frequency bands. For example, the different radio access technologies may include a wireless LAN (e.g., IEEE 802.11), a cellular network (e.g., LTE), and the like. In addition, the different frequency bands may include a super-high-frequency (SHF) (e.g., 2.NRHz, NRhz) band and a millimeter-wave (e.g., 60 GHz) band.

The storage 1m-30 may store data such as a basic program, an application, or configuration information for the operation of the UE. In particular, the storage 1m-30 stores information related to a second access node which performs wireless communication by using the second wireless access technology. In addition, the storage 1m-30 provides stored data upon a request from the controller 1m-40.

The controller 1m-40 controls the overall operations of the UE. For example, the controller 1m-40 transmits or receives signals through the baseband processor 1m-20 and the RF processor 1m-10. In addition, the controller 1m-40 records and reads data in and from the storage 1m-30. To this end, the controller 1m-40 may include at least one processor. For example, the controller 1m-40 may include a communication processor that performs control for communication and an application processor (AP) that controls a higher layer such as an application.

FIG. 1N is a block diagram illustrating a configuration of an NR base station in a wireless communication system according to an embodiment of the disclosure.

Referring to FIG. 1N, the base station may include an RF processor 1n-10, a baseband processor 1n-20, a backhaul communication unit 1n-30, a storage 1n-40, and a controller 1n-50.

The RF processor 1n-10 performs a function of transmitting or receiving a signal via a wireless channel, such as band conversion and amplification of the signal. That is, the RF processor 1n-10 up-converts a baseband signal provided from the baseband processor 1n-20 to an RF band signal and then transmits the same through an antenna, and down-converts an RF band signal received through the antenna to a baseband signal. For example, the RF processor 1n-10 may include a transmission filter, a reception filter, an amplifier, a mixer, an oscillator, a DAC, and/or an analog-to-digital converter (ADC), etc. In FIG. 1N, although only one antenna is illustrated, a first connection node may include multiple antennas. In addition, the RF processor 1n-10 may include multiple RF chains. Furthermore, the RF processor 1n-10 may perform beamforming. For the beamforming, the RF processor 1n-10 may adjust the phase and magnitude of each of signals transmitted or received through multiple antennas or antenna elements. The RF processor may perform down-MIMO operations by transmitting one or more layers.

The baseband processor 1n-20 performs a function of conversion between a baseband signal and a bit stream according to the physical layer standard of a first radio access technology. For example, during data transmission, the baseband processor 1n-20 generates complex symbols by coding and modulating a transmission bit stream. In addition, upon receiving data, the baseband processor 1n-20 restores the received bit stream through demodulation and decoding of the baseband signal provided from the RF processor 1n-10. For example, in a case of conforming to the OFDM method, when transmitting data, the baseband processor 1n-20 performs coding and modulation of a transmission bit stream to generate complex symbols, maps the complex symbols to subcarriers, and then configures OFDM symbols via an IFFT operation and CP insertion. In addition, when receiving data, the baseband processor 1n-20 divides the baseband signal provided from the RF processor 1n-10 into units of OFDM symbols, restores signals mapped to subcarriers via the FFT operation, and then restores a received bit stream via demodulation and decoding. The baseband processor 1n-20 and the RF processor 1n-10 transmit and receive signals as described above. Accordingly, each of the baseband processor 1n-20 and the RF processor 1n-10 may be referred to as a transmitter, a receiver, a transceiver, or a wireless communication unit.

The backhaul communication unit 1n-30 provides an interface for performing communication with other nodes in a network. That is, the backhaul communication unit 1n-30 converts a bit stream transmitted from a main base station to another node, for example, an auxiliary base station or a core network, into a physical signal, and converts the physical signal received from the other node into a bit stream.

The storage 1n-40 stores data such as a basic program, an application, and configuration information for the operation of the main base station. In particular, the storage 1n-40 may store information on bearers allocated to the connected UE, measurement results reported from the connected UE, and the like. In addition, the storage 1n-40 may store information serving as a criterion for determining whether to provide or stop multiple connections to the UE. In addition, the storage 1n-40 provides stored data upon a request from the controller 1n-50.

The controller 1n-50 controls the overall operations of the main base station. For example, the controller 1n-50 transmits or receives signals through the baseband processor 1n-20 and the RF processor 1n-10 or through the backhaul communication unit 1n-30. In addition, the controller 1n-50 records and reads data in and from the storage 1n-40. To this end, the controller 1n-50 may include at least one processor.

According to various embodiments of the disclosure, a method performed by an uncrewed aerial vehicle (UAV) UE in a radio resource control (RRC)_IDLE or an RRC_INACTIVE state may be provided. The method may include receiving a message including system information from a base station, wherein the system information includes first information indicating whether the UAV UE can be connected, and performing, based on the first information, camp-on on the base station in response to the received message including the system information.

According to an embodiment of the disclosure, the method may further include performing, based on second information, camp-on on the base station, wherein the system information further includes the second information indicating a height threshold.

According to an embodiment of the disclosure, the method may include performing, based on third information, camp-on on another base station different from the base station, wherein the system information further includes the third information indicating whether a cell using an identical frequency can be reselected.

According to an embodiment of the disclosure, the system information may include at least one of a master information block (MIB) or system information block #1 (SIB1).

According to various embodiments of the disclosure, a method performed by a base station may be provided. The method may include transmitting a message including system information to an uncrewed aerial vehicle (UAV) UE in a radio resource control (RRC)_IDLE or an RRC_INACTIVE state, wherein the system information includes first information indicating whether the UAV UE can be connected, and performing, based on the first information, communication with the UAV UE in the RRC_IDLE or RRC_INACTIVE state in response to the transmitted message including the system information.

According to an embodiment of the disclosure, the method may further include performing, based on second information, communication with the UAV UE in the RRC_IDLE or RRC_INACTIVE state, wherein the system information further includes the second information indicating a height threshold.

According to an embodiment of the disclosure, the system information may further include third information indicating whether a cell using an identical frequency can be reselected.

According to various embodiments of the disclosure, an uncrewed aerial vehicle (UAV) UE in a radio resource control (RRC)_IDLE or an RRC_INACTIVE state may be provided. The UAV UE in the RRC_IDLE or the RRC_INACTIVE state may include a transceiver and a controller connected to the transceiver, wherein the controller is configured to receive a message including system information from a base station, the system information including first information indicating whether the UAV UE can be connected, and performing, based on the first information, camp-on on the base station in response to the received message including the system information.

According to various embodiments of the disclosure, a base station may include a transceiver and a controller connected to the transceiver, wherein the controller is configured to transmit a message including system information to an uncrewed aerial vehicle (UAV) UE in a radio resource control (RRC)_IDLE or an RRC_INACTIVE state, the system information including first information indicating whether the UAV UE can be connected, and performing, based on the first information, communication with the UAV UE in the RRC_IDLE or

RRC_INACTIVE state in response to the transmitted message including the system information.

The disclosure provides a method of an uncrewed aerial vehicle (UAV) UE in a radio resource control (RRC)_IDLE or an RRC_INACTIVE state includes receiving a message including system information, wherein the system information includes first information indicating whether the UAV UE can be connected, second information indicating whether the UAV UE can reselect neighboring cells using an identical frequency, and third information indicating a height threshold, performing, based on the first information indicating whether the UAV UE can be connected, camp-on on the cell in case that the height of the UAV UE is equal to or greater than the height threshold, and reselecting, based on the second information indicating whether the UAV UE can reselect neighboring cells using the same frequency, neighboring cells using the same frequency as the cell in case that the height of the UAV UE is equal to or greater than the height threshold.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims as described below and equivalents thereof. That is, it will be apparent to those skilled in the art that other variants based on the technical idea of the disclosure may be implemented. Also, the above respective embodiments may be employed in combination, as necessary. For example, the methods proposed in the disclosure may be partially combined with each other to operate a network entity and a terminal. Moreover, although the above embodiments have been described based on 5G and NR systems, other variants based on the technical idea of the embodiments may also be implemented in other communication systems such as LTE, LTE-A, and LTE-A-Pro systems.

1. A method performed by an uncrewed aerial vehicle (UAV) terminal in a radio resource control (RRC)_IDLE or an RRC_INACTIVE state, the method comprising:
receiving a message comprising system information from a base station, wherein the system information comprises first information indicating whether the UAV terminal can be connected; and
performing, based on the first information, camp-on on the base station in response to the received message comprising the system information.

2. The method of claim 1, further comprising performing, based on second information, camp-on on the base station,
wherein the system information further comprises the second information indicating a height threshold.

3. The method of claim 1, further comprising performing, based on third information, camp-on on another base station different from the base station,
wherein the system information further comprises the third information indicating whether a cell using an identical frequency can be reselected.

4. The method of claim 1, wherein the system information comprises at least one of a master information block (MIB) or system information block #1 (SIB1).

5. A method performed by a base station, the method comprising:
transmitting a message comprising system information to an uncrewed aerial vehicle (UAV) terminal in a radio resource control (RRC)_IDLE or an RRC_INACTIVE state,
wherein the system information comprises first information indicating whether the UAV terminal can be connected; and
performing, based on the first information, communication with the UAV terminal in the RRC_IDLE or RRC_INACTIVE state in response to the transmitted message comprising the system information.

6. The method of claim 5, further comprising performing, based on second information, communication with the UAV terminal in the RRC_IDLE or RRC INACTIVE state,
wherein the system information further comprises the second information indicating a height threshold.

7. The method of claim 5, wherein the system information further comprises third information indicating whether a cell using an identical frequency can be reselected.

8. An uncrewed aerial vehicle (UAV) terminal in a radio resource control (RRC)_IDLE or an RRC INACTIVE state, the terminal comprising:
a transceiver; and
a controller connected to the transceiver,
wherein the controller is configured to:
receive a message comprising system information from a base station,
wherein the system information comprises first information indicating whether the UAV terminal can be connected; and
perform, based on the first information, camp-on on the base station in response to the received message comprising the system information.

9. The terminal of claim 8, wherein the system information further comprises second information indicating a height threshold, and
wherein the controller is further configured to perform, based on the second information, camp-on on the base station.

10. The terminal of claim 8, wherein the system information further comprises third information indicating whether a cell using an identical frequency can be reselected, and
wherein the controller is further configured to perform, based on the third information, camp-on on another base station different from the base station.

11. The terminal of claim 8, wherein the system information comprises at least one of a master information block (MIB) or system information block #1 (SIB1).

12. A base station comprising:
a transceiver; and
a controller connected to the transceiver,
wherein the controller is configured to:
transmit a message comprising system information to an uncrewed aerial vehicle (UAV) terminal in a radio resource control (RRC)_IDLE or an RRC_INACTIVE state,
wherein the system information comprises first information indicating whether the UAV terminal can be connected; and
perform, based on the first information, communication with the UAV terminal in the RRC_IDLE or RRC_INACTIVE state in response to the transmitted message comprising the system information.

13. The base station of claim 12, wherein the system information further comprises second information indicating a height threshold, and
wherein the controller is further configured to perform, based on the second information, communication with the UAV terminal in the RRC_IDLE or RRC_INACTIVE state.

14. The base station of claim 12, wherein the system information further comprises third information indicating whether a cell using an identical frequency can be reselected.

15. The base station of claim 12, wherein the system information comprises at least one of a master information block (MIB) or system information block #1 (SIB1).
